(19) United States
(12) Patent Application Publication
(10) Pub. No.: US 2026/0250544 A1
(43) Pub. Date: Aug. 27, 2026

(54) PHA DISPERSION COATING COMPOSITION AND COATED FIBER-BASED SUBSTRATE

(71) Applicant: Stora Enso OYJ, Helsinki (FI)

(72) Inventors: Kaj Backfolk, Lappeenranta (FI); Åsa Nyflött, Karlstad (SE); Gisela Cunha, Nacka (SE); Saina Kishani, Solna (SE)

(73) Assignee: Stora Enso OYJ, Helsinki (FI)

(21) Appl. No.: 19/163,151

(22) PCT Filed: Mar. 5, 2024
(86) PCT No.: PCT/IB2024/052120

§ 371 Date: Sep. 8, 2025

(30) Foreign Application Priority Data
Mar. 20, 2023 (SE) 2330129-4

(51) Int. Cl. C09D 167/04; C08K 5/053; C09D 7/45; C09D 7/63; D21H 19/12; D21H 27/10

(52) U.S. Cl. CPC C09D 167/04; C09D 7/45; C09D 7/63; D21H 19/12; D21H 27/10; C08K 5/053

(57) ABSTRACT

The present invention relates to a dispersion coating composition for coating of a fiber-based substrate, said dispersion coating composition comprising, in a liquid medium: 50-99 wt % of PHA (polyhydroxyalkanoate) particles, based on the total solid content of the dispersion coating composition, and 1-50 wt % of low molecular weight polyol dispersant, based on the total solid content of the dispersion coating composition, wherein the dispersion coating composition has a total solid content in the range of 20-80 wt %. The present invention further relates to a fiber-based substrate coated with such a dispersion coating composition and to a packaging container comprising such a dispersion coated fiber-based substrate.

### TECHNICAL FIELD

The present disclosure relates to methods for preparing coated fiber-based substrates, specifically polyhydroxyalkanoate (PHA) coated paper or paperboard, for use as packaging materials.

### BACKGROUND

Coating of fiber-based substrates, such as paper and paperboard, with plastics is often used to combine the mechanical properties of the fiber-based substrate with the barrier and sealing properties of a plastic film. Paper or paperboard provided with even a relatively small amount of a suitable plastic material can provide the properties needed to make the paper or paperboard suitable for many demanding applications, for example as liquid or food packaging board.

In addition to a liquid barrier on the inside of the package, fiber-based packaging products such as cups or trays that are intended especially for packaging cold products must typically also be provided with a condensation layer on the outside of the package. This condensation layer prevents condensate from softening the bulky fiber-based substrate. The packaging product is further typically provided with at least one heat sealable liquid barrier on the inside.

In liquid or food packaging board, extrusion coated polyolefin coatings are frequently used as liquid barrier layers, heat sealing layers and adhesives. However, the recycling of such polymer coated board is difficult since it is difficult to separate the polymers from the fibers.

In the prior art, attempts have been made to replace extrusion coated polyolefin coatings with more environmentally friendly and/or easier to recycle solutions, but so far with no real success. In many cases some, but not all, of the properties of the extrusion coated polyolefin coatings are achieved by alternative solutions.

Dispersion barrier coatings for paper and paperboard is an interesting alternative to extrusion coating for improving repulpability and recyclability of barrier coated fiber-based substrates. Dispersion coating is especially useful as it can be implemented on-line in paper or paperboard machines. Many dispersions or emulsions such as styrene/acrylate or styrene/butadiene emulsions are, however, not biodegradable or compostable.

Dispersion coating barriers based on polyhydroxyalkanoates (PHA), on the other hand, are both compostable and biodegradable. The challenge with PHA dispersions is to find a suitable composition, which enables good coater runnability, good coating coverage (hold-out), and good barrier performance. Coating coverage, and subsequent barrier performance, is very dependent on substrate roughness and coat weight, whereas higher coat weights have a negative impact on recyclability, drying efficiency, and cost. PHA dispersions are usually stabilized with surfactants and/or surface active polymers, which may cause uneven barrier quality due to migration of dispersants, or to higher foaming tendency. The foaming tendency may further create problems when recycling and repulping or disintegrating the coated web.

Many of the aforementioned problems can be avoided by applying the PHA using melt extrusion coating. However, extrusion coating of PHA is unfortunately not implementable on-line on full scale paper or paperboard machines. Also, extrusion coating usually requires relatively high coat weights and leads to inferior adhesion as compared to dispersion coated grades, and extrusion coated grades are more difficult to re-pulp than dispersion coated grades.

Thus, there remains a need for improved solutions to replace conventional plastic coatings, especially polyolefin coatings, in paper and paperboard based packaging materials, while maintaining acceptable liquid barrier properties. At the same time, there is a need for liquid barrier layers for fiber-based substrates, such as paper or paperboard substrates that facilitate repulping and recycling of the used packaging materials as compared to packaging laminates using conventional plastic films.

### DESCRIPTION OF THE INVENTION

It is an object of the present disclosure to provide an alternative to the plastic films commonly used as barrier layers for providing liquid barrier properties in paper or paperboard based packaging materials, such as liquid or food packaging board.

It is a further object of the present disclosure to provide a liquid barrier layer for a paper or paperboard based packaging material, such as a liquid or food packaging board, which is based on renewable raw materials.

It is a further object of the present disclosure to provide a liquid barrier layer for a paper or paperboard based packaging material, such as a liquid or food packaging board, which facilitates re-pulping of the packaging material as compared to packaging laminates using conventional plastic films.

It is a further object of the present disclosure to provide an improved PHA coating dispersion, which overcomes or ameliorates at least some of the problems associated with previous PHA coating dispersions.

The above-mentioned objects, as well as other objects as will be realized by the skilled person in the light of the present disclosure, are achieved by the various aspects of the present disclosure.

The present invention is based on the understanding that the problems associated with dispersion coating of PHA dispersions on fiber-based substrates can be overcome by using a relatively high amount of a low molecular weight polyol as a dispersant for the PHA particles. A surprising observation is that the high amounts of a low molecular weight polyol does not negatively affect the barrier properties of the PHA coating. Typically, dispersants are used in amounts less than 1 wt % as it would be expected that the dispersant would deteriorate the barrier properties of the PHA coating.

According to a first aspect illustrated herein, there is provided a dispersion coating composition for coating of a fiber-based substrate, said dispersion coating composition comprising, in a liquid medium:
50-99 wt % of PHA (polyhydroxyalkanoate) particles, based on the total solid content of the dispersion coating composition, and
1-50 wt % of low molecular weight polyol dispersant, based on the total solid content of the dispersion coating composition,
   wherein the dispersion coating composition has a total solid content in the range of 20-80 wt %.

The PHA particles are preferably the main component of the dispersion coating composition based on dry weight of the composition. In some embodiments, the dispersion coating composition comprises at least 50 wt %, at least 65 wt %, at least 70 wt %, or at least 90 wt % of PHA particles based on the total solid content of the dispersion coating composition. In some embodiments, the dispersion coating composition comprises 70-99 wt %, preferably 90-99 wt %, of PHA particles based on the total solid content of the dispersion coating composition. In some embodiments, the dispersion coating composition comprises 50-97 wt %, 50-95 wt %, 50-92.5 wt %, 50-90 wt %, 50-87.5 wt %, or 50-85 wt %, of PHA particles based on the total solid content of the dispersion coating composition. In some embodiments, the dispersion coating composition comprises 65-97 wt %, 65-95 wt %, 65-92.5 wt %, 65-90 wt %, 65-87.5 wt %, or 65-85 wt %, of PHA particles based on the total solid content of the dispersion coating composition. In some embodiments, the dispersion coating composition comprises 70-97 wt %, 70-95 wt %, 70-92.5 wt %, 70-90 wt %, 70-87.5 wt %, or 70-85 wt %, of PHA particles based on the total solid content of the dispersion coating composition. In some embodiments, the dispersion coating composition comprises 90-97 wt %, 90-95 wt %, 90-92.5 wt %, of PHA particles based on the total solid content of the dispersion coating composition.

The particle size distribution of the PHA particles can be multimodal or unimodal. In some embodiments, the PHA particles have a unimodal or bimodal particle size distribution. In some embodiments, the PHA particles have a unimodal particle size distribution.

In some embodiments, the PHA particles have a median particle size (D50) below 15 μm, preferably below 12 μm, and more preferably in the range of 0.5-11 μm or in the range of 0.8-8 μm.

In some embodiments, the dispersion coating composition is free from, or substantially free from particles or particle agglomerates having a particle size above 50 μm, above 20 μm, or above 15 μm.

Unless stated otherwise, all particle sizes and particle size distributions herein are determined by a laser diffraction method using a Mastersizer 3000 according to ISO 13320:2009.

In some embodiments, the PHA particles comprise PHA in an amount of 70-99.9 wt %, preferably in an amount of 90-99.9 wt %, based on the dry weight of the PHA particles.

In some embodiments, the PHA is selected from the group consisting of poly(3-hydroxyoctanoate) (PHO), poly(3-hydroxydecanoate) (PHD), poly(3-hydroxyhexanoate) (PHH), and poly(3-hydroxyvalerate) (PHV), poly(3-hydroxybutyrate-co-3-hydroxyvalerate) (PHBV), poly(3-hydroxybutyrate-co-3-hydroxyhexanoate) (PHBH), poly(3-hydroxybutyrate-co-4-hydroxybutyrate) (P3HB4HB), poly(3-hydroxyoctanoate-co-3-hydroxyhexanoate) (PHOHH), poly(3-hydroxyoctanoate-co-3-hydroxydecanoate) (PHOHD), and poly(3-hydroxyoctanoate-co-3-hydroxydodecanoate) (PHDHDD), or a combination thereof. The skilled person understands that the PHA suitable for use in the dispersion coating composition is not limited to those listed here.

In some embodiments, the PHA is a PHA co-polymer.

In some embodiments, the PHA is selected from the group consisting of poly(3-hydroxybutyrate-co-3-hydroxyvalerate) (PHBV), poly(3-hydroxybutyrate-co-3-hydroxyhexanoate) (PHBH), poly(3-hydroxybutyrate-co-4-hydroxybutyrate) (P3HB4HB), poly(3-hydroxyoctanoate-co-3-hydroxyhexanoate) (PHOHH), poly(3-hydroxyoctanoate-co-3-hydroxydecanoate) (PHOHD), and poly(3-hydroxyoctanoate-co-3-hydroxydodecanoate) (PHDHDD), or a combination thereof. The skilled person understands that the PHA co-polymers suitable for use in the dispersion coating composition are not limited to those listed here.

In some embodiments, the PHA is a medium chain length PHA, preferably a PHA having 6-14 carbon atoms per monomer unit.

The type of PHA suitable for use in the dispersion coating composition may be characterized by its melting point. In some embodiments, the PHA has a melting point in the range of 100-170° C. preferably in the range of 120-160° C. Unless stated otherwise, the melting points mentioned herein are determined by differential scanning calorimetry according to standard ASTM D3418.

The PHA for use in the dispersion coating composition is preferably biodegradable and compostable.

The inventive dispersion coating composition comprises 1-50 wt % of low molecular weight polyol dispersant, based on the total solid content of the dispersion coating composition. Dispersants are usually low molecular polymers which are used for improving the colloidal stability of a dispersion, and reducing viscosity (due to less floc formation, etc.). Dispersants are not normally used for improving barrier properties of a coating. In fact, many dispersants, especially at higher concentrations, are expected to migrate and deteriorate the barrier properties of a barrier coating.

In some embodiments, the dispersion coating composition comprises 3-35 wt %, and more preferably 5-30 wt %, of the low molecular weight polyol dispersant, based on the total solid content of the dispersion coating composition. In some embodiments, the dispersion coating composition comprises 7.5-35 wt %, preferably 10-35 wt %, more preferably 12.5-35 wt %, and more preferably 15-35 wt % of the low molecular weight polyol dispersant, based on the total solid content of the dispersion coating composition. In some embodiments, the dispersion coating composition comprises 7.5-30 wt %, preferably 10-30 wt %, more preferably 12.5-30 wt %, and more preferably 15-30 wt % of the low molecular weight polyol dispersant, based on the total solid content of the dispersion coating composition. In some embodiments, the dispersion coating composition comprises 7.5-25 wt %, preferably 10-25 wt %, more preferably 12.5-25 wt %, and more preferably 15-25 wt % of the low molecular weight polyol dispersant, based on the total solid content of the dispersion coating composition.

In some embodiments, the dispersion coating composition comprises 3-35 wt % of the low molecular weight polyol dispersant and 65-97 wt % of PHA particles, or 5-30 wt % of the low molecular weight polyol dispersant and 70-95 wt % of PHA particles, based on the total solid content of the dispersion coating composition. In some embodiments, the dispersion coating composition comprises 7.5-30 wt % of the low molecular weight polyol dispersant and 70-92.5 wt % of PHA particles, or 10-30 wt % of the low molecular weight polyol dispersant and 70-90 wt % of PHA particles, or 12.5-30 wt % of the low molecular weight polyol dispersant and 70-87.5 wt % of PHA particles, or 15-30 wt % of the low molecular weight polyol dispersant and 70-85 wt % of PHA particles, based on the total solid content of the dispersion coating composition.

In some embodiments, the low molecular weight polyol dispersant has a molecular weight in the range of 50-2000 g/mol, preferably in the range of 50-1500 g/mol, and more preferably in the range of 50-1000 g/mol or in the range of 50-500 g/mol.

In some embodiments, the low molecular weight polyol dispersant is selected from the group consisting of low molecular weight polysaccharides and sugar alcohols, and combinations thereof.

In some embodiments, the low molecular weight polyol dispersant is selected from the group consisting of low molecular weight polysaccharides having a degree of polymerization (DP) in the range of 2-100, preferably in the range of 2-50. In some embodiments, the low molecular weight polyol dispersant is selected from the group consisting of low molecular weight polysaccharides having a degree of polymerization (DP) in the range of 2-12. The low molecular weight polysaccharides may be charged, uncharged, amphoteric, or combination thereof. The low molecular weight polysaccharides may be linear or branched.

In some embodiments, the low molecular weight polyol dispersant is a sugar alcohol, preferably a sugar alcohol selected from the group consisting of sorbitol, maltitol, xylitol, mannitol, and glycerol, and combinations thereof. In some embodiments, the low molecular weight polyol dispersant is selected from the group consisting of sorbitol, maltitol, xylitol, mannitol, and combinations thereof. In some embodiments, the low molecular weight polyol dispersant is sorbitol.

In some embodiments, the dispersion coating composition further comprises 0.01-15 wt %, preferably in the range of 0.01-10 wt %, and more preferably in the range of 0.1-5 wt %, of a rheology modifier, based on the total solid content of the dispersion coating composition. The rheology modifier is used for adjusting the viscosity and water retention of the dispersion coating composition such that it is suitable for application by the preferred application method.

In some embodiments, the rheology modifier comprises a polymer selected from the group consisting of polysaccharides, polysaccharide derivatives, polypeptides, polypeptide derivatives, or a combination thereof.

In some embodiments, the dispersion coating composition further comprises 1-30 wt % of filler particles, based on the total solid content of the dispersion coating composition. Too much filler particles can lead to cracking and deterioration of barrier properties. The amount of filler particles is preferably 5-25 wt %, and more preferably 5-15 wt %, based on the total solid content of the dispersion coating composition.

In some embodiments, the filler particles are selected from the group consisting of clay (such as kaolin or calcined kaolin), talcum, CaCO₃ (such as PCC or GCC), TiO₂, Al₂O₃, SiO₂, bentonite, fibers, phyllosilicates, or a combination thereof. The filler particles are preferably high aspect ratio filler particles, e.g. flaky particles having median particle size (D90) below 2 μm.

In some embodiments, the dispersion coating composition comprises at least 50 wt % of PHA (polyhydroxyalkanoate) particles, the low molecular weight polyol dispersant in the amounts disclosed herein, optionally a rheology modifier in the amounts disclosed herein, and optionally filler particles in the amounts disclosed herein, based on the total solid content of the dispersion coating composition. In some embodiments, the dispersion coating composition comprises at least 70 wt % of PHA (polyhydroxyalkanoate) particles, 7.5-30 wt % of the low molecular weight polyol dispersant, 0.1-5 wt % of the rheology modifier, and optionally 5-25 wt % of the filler particles, based on the total solid content of the dispersion coating composition.

In some embodiments, the dispersion coating composition may also comprise further additives such as lubricants, humectants or softeners, sizing agents, dewatering accelerators, slimicides, wet-strength agents, pH adjusting agents, defoamers, crosslinkers, biocides, preservatives, and/or colorants.

In some embodiments, the dispersion coating composition is free from added foaming agents, such as non-polymeric or polymeric surfactants. In some embodiments, the dispersion coating composition comprises less than 0.5 wt %, preferably less than 0.1 wt %, more preferably less than 0.01 wt %, of added foaming agents, such as non-polymeric or polymeric surfactants.

In some embodiments, the dispersion coating composition is de-aerated. The low molecular weight polyol dispersant is advantageous in this respect since a low molecular weight polyol dispersant is less prone to entrapping gas bubbles than a high molecular weight dispersant. Thus, in some embodiments, the dispersion coating composition is preferably free from, or substantially free from bubbles of air and other gases.

In some embodiments, the dispersion coating composition has a total solid content in the range of 30-70 wt %, preferably in the range of 40-60 wt %.

In some embodiments, the dispersion coating composition has a viscosity in the range of 50-4000 mPas, preferably in the range of 250-3500 mPas, determined according to SCAN-P50:84 using a Brookfield viscosimeter with an LV-4 spindle at a rotational speed of 100 rpm.

In some embodiments, the dispersion coating composition has a ÅAGWR water retention value (Åbo Akademi Water retention value) of less than 250 g/m², preferably less than 200 g/m², and more preferably in the range of 50-150 g/m², determined according to TAPPI T701 μm-0.

The liquid medium may comprise water, organic solvent, or a mixture of water and organic solvent. In some embodiments, the liquid medium is water.

The dispersion coating composition according to the first aspect described herein allows for the preparation of improved PHA coated fiber-based substrate.

According to a second aspect illustrated herein, there is provided a dispersion coated fiber-based substrate, comprising
a fiber-based substrate having a first main surface and a second main surface,
a dispersion coating layer comprising
   50-99 wt % of PHA (polyhydroxyalkanoate) particles, based on the total solid content of the dispersion coating layer, and
   1-50 wt % of low molecular weight polyol dispersant, based on the total solid content of the dispersion coating layer,
on the first main surface.

The fiber-based substrate (also referred to herein as “the substrate”) is preferably a sheet or web of material mainly formed from pulp of wood or other fibrous substances. In some embodiments, the fiber-based substrate is paper or paperboard, preferably paperboard.

Paper generally refers to a material manufactured in sheets or rolls from the pulp of wood or other fibrous substances comprising cellulose fibers, used for e.g. writing, drawing, or printing on, or as packaging material. Paper can either be bleached or unbleached and produced in a variety of thicknesses, depending on the end-use requirements.

Paperboard generally refers to strong, thick paper or cardboard comprising cellulose fibers used for example as flat substrates, trays, boxes and/or other types of packaging. Paperboard can either be bleached or unbleached and produced in a variety of thicknesses, depending on the end-use requirements.

In some embodiments, the fiber-based substrate is comprised of two or more cellulose-based plies. Each of the cellulose-based plies can have a certain composition of pulp fibers, such as bleached and/or unbleached Kraft pulp, sulfite pulp, dissolving pulp, thermomechanical pulp (TMP), chemi-thermomechanical pulp (CTMP), pressurized groundwood (PGW), high-temperature CTMP (HT-CTMP), broke, recycled fiber, including pre- and post-consumer waste, and/or mixtures thereof. The different plies can have different grammages and/or thicknesses and may contain different amounts of additives, such as internal sizing agents.

As an example, the fiber-based substrate can be built up of one top-ply consisting of bleached or unbleached Kraft pulp, a mid-ply consisting of a mixture of bleached or unbleached Kraft pulp and CTMP, and a bottom-ply consisting of bleached or unbleached Kraft pulp, wherein the mid-ply has a higher thickness and/or lower density than both the top and bottom plies, respectively.

A preferred fiber-based substrate is a paper or paperboard having high content of unbleached fibers, such as at least 50 wt % in at least one of the plies, thus forming rough surface but with good mechanical performance and a natural look.

In some embodiments, the basis weight of the fiber-based substrate is in the range of 20-800 g/m². In some embodiments, the fiber-based substrate has a grammage of at least 100 g/m². In some embodiments, the fiber-based substrate has a grammage of at least 150 g/m², 200 g/m², 250 g/m², 300 g/m², 350 g/m², or 400 g/m². The grammage of the fiber-based substrate is preferably below 1000 g/m², 800 g/m², or 600 g/m². Unless otherwise stated, the grammage is determined according to the standard ISO 536.

The fiber-based substrate may also be surface sized or impregnated. In some embodiments, the fiber-based substrate is surface sized or impregnated on one or both sides with a surface sizing composition, preferably comprising a starch derivative, a cellulose derivative, or polyvinyl alcohol (PVOH) or a combination of thereof. The starch derivative may for example be a slightly modified, such as oxidized or cationized starch. The cellulose derivative may for example be a sodium carboxymethyl cellulose with a degree of substitution higher than 0.4 such as in the range of 0.5-1.5. The PVOH may be fully or partly hydrolyzed. The surface sizing composition may also comprise a hydrophobic sizing agent, such as alkyl ketene dimer (AKD), alkenyl succinic anhydride (ASA), or a rosin sizing agent. The fiber-based substrate is preferably surface sized or impregnated on the first main surface to be subjected to the dispersion coating. The surface sizing or impregnation may provide a more even, and less water absorbent surface for the dispersion coating composition. The surface sizing or impregnation may also facilitate the release of the PHA coating structure from the fiber-based substrate during repulping.

In some embodiments, the grammage of the surface sizing composition is 0.2-10 g/m², preferably 0.4-8 g/m², and more preferably 0.8-5 g/m² per side, based on dry weight.

The fiber-based substrate itself, before PHA coating, may have a relatively high permeability for liquids, such as water, oil and grease, water vapor and gases, such as oxygen, air and carbon dioxide. In some embodiments, the fiber-based substrate has a water vapor transmission rate (WVTR), measured according to the standard ASTM F1249-20 at 50% relative humidity and 23° C., of at least 200 g/m²/24 h. In some embodiments, the fiber-based substrate has a COBB60 value as measured according to the standard ISO 535:2014 of less than 100 g/m², preferably less than 80 g/m², less than 60 g/m², or less than 40 g/m².

The fiber-based substrate itself, before PHA coating, preferably has a L&W (15°) bending resistance of at least 145 mN (MD) as determined according to ISO 2493-1.

The PHA particles are preferably the main ingredient of the dispersion coating layer based on the total solid content of the dispersion coating layer. In some embodiments, the dispersion coating layer comprises at least 50 wt %, at least 65 wt %, at least 70 wt %, or at least 90 wt % of PHA particles based on the total solid content of the dispersion coating layer. In some embodiments, the dispersion coating layer comprises 70-99 wt %, preferably 90-99 wt %, of PHA particles based on the total solid content of the dispersion coating layer. In some embodiments, the dispersion coating layer comprises 50-97 wt %, 50-95 wt %, 50-92.5 wt %, 50-90 wt %, 50-87.5 wt %, or 50-85 wt %, of PHA particles based on the total solid content of the dispersion coating layer. In some embodiments, the dispersion coating layer comprises 65-97 wt %, 65-95 wt %, 65-92.5 wt %, 65-90 wt %, 65-87.5 wt %, or 65-85 wt %, of PHA particles based on the total solid content of the dispersion coating layer. In some embodiments, the dispersion coating layer comprises 70-97 wt %, 70-95 wt %, 70-92.5 wt %, 70-90 wt %, 70-87.5 wt %, or 70-85 wt %, of PHA particles based on the total solid content of the dispersion coating layer. In some embodiments, the dispersion coating layer comprises 90-97 wt %, 90-95 wt %, 90-92.5 wt %, of PHA particles based on the total solid content of the dispersion coating layer.

The particle size distribution of the PHA particles can be multimodal or unimodal. In some embodiments, the PHA particles have a unimodal or bimodal particle size distribution. In some embodiments, the PHA particles have a unimodal particle size distribution.

In some embodiments, the PHA particles have a median particle size (D50) below 15 μm, preferably below 12 μm, and more preferably in the range of 0.5-11 μm or in the range of 0.8-8 μm.

In some embodiments, the dispersion coating layer is free from, or substantially free from particles or particle agglomerates having a particle size above 50 μm, above 20 μm, or above 15 μm.

In some embodiments, the PHA particles comprise PHA in an amount of 70-99.9 wt %, preferably in an amount of 90-99.9 wt %, based on the dry weight of the PHA particles.

In some embodiments, the PHA is selected from the group consisting of poly(3-hydroxyoctanoate) (PHO), poly(3-hydroxydecanoate) (PHD), poly(3-hydroxyhexanoate) (PHH), and poly(3-hydroxyvalerate) (PHV), poly(3-hydroxybutyrate-co-3-hydroxyvalerate) (PHBV), poly(3-hydroxybutyrate-co-3-hydroxyhexanoate) (PHBH), poly(3-hydroxybutyrate-co-4-hydroxybutyrate) (P3HB4HB), poly(3-hydroxyoctanoate-co-3-hydroxyhexanoate) (PHOHH), poly(3-hydroxyoctanoate-co-3-hydroxydecanoate) (PHOHD), and poly(3-hydroxyoctanoate-co-3-hydroxydodecanoate) (PHDHDD), or a combination thereof.

In some embodiments, the PHA is a PHA co-polymer.

In some embodiments, the PHA is selected from the group consisting of poly(3-hydroxybutyrate-co-3-hydroxyvalerate) (PHBV), poly(3-hydroxybutyrate-co-3-hydroxyhexanoate) (PHBH), poly(3-hydroxybutyrate-co-4-hydroxybutyrate) (P3HB4HB), poly(3-hydroxyoctanoate-co-3-hydroxyhexanoate) (PHOHH), poly(3-hydroxyoctanoate-co-3-hydroxydecanoate) (PHOHD), and poly(3-hydroxyoctanoate-co-3-hydroxydodecanoate) (PHDHDD), or a combination thereof.

In some embodiments, the PHA is a medium chain length PHA, preferably a PHA having 6-14 carbon atoms per monomer unit.

In some embodiments, the PHA has a melting point in the range of 100-170° C. preferably in the range of 120-160° C.

In some embodiments, the dispersion coating layer comprises 3-35 wt %, and more preferably 5-30 wt %, of the low molecular weight polyol dispersant, based on the total solid content of the dispersion coating layer. In some embodiments, the dispersion coating layer comprises 7.5-35 wt %, preferably 10-35 wt %, more preferably 12.5-35 wt %, and more preferably 15-35 wt % of the low molecular weight polyol dispersant, based on the total solid content of the dispersion coating layer. In some embodiments, the dispersion coating layer comprises 7.5-30 wt %, preferably 10-30 wt %, more preferably 12.5-30 wt %, and more preferably 15-30 wt % of the low molecular weight polyol dispersant, based on the total solid content of the dispersion coating layer. In some embodiments, the dispersion coating layer comprises 7.5-25 wt %, preferably 10-25 wt %, more preferably 12.5-25 wt %, and more preferably 15-25 wt % of the low molecular weight polyol dispersant, based on the total solid content of the dispersion coating layer.

In some embodiments, the dispersion coating layer comprises 3-35 wt % of the low molecular weight polyol dispersant and 65-97 wt % of PHA particles, or 5-30 wt % of the low molecular weight polyol dispersant and 70-95 wt % of PHA particles, based on the total solid content of the dispersion coating layer. In some embodiments, the dispersion coating layer comprises 7.5-30 wt % of the low molecular weight polyol dispersant and 70-92.5 wt % of PHA particles, or 10-30 wt % of the low molecular weight polyol dispersant and 70-90 wt % of PHA particles, or 12.5-30 wt % of the low molecular weight polyol dispersant and 70-87.5 wt % of PHA particles, or 15-30 wt % of the low molecular weight polyol dispersant and 70-85 wt % of PHA particles, based on the total solid content of the dispersion coating layer.

In some embodiments, the low molecular weight polyol dispersant has a molecular weight in the range of 50-2000 g/mol, preferably in the range of 50-1500 g/mol, and more preferably in the range of 50-1000 g/mol or in the range of 50-500 g/mol.

In some embodiments, the low molecular weight polyol dispersant is selected from the group consisting of low molecular weight polysaccharides and sugar alcohols, and combinations thereof.

In some embodiments, the low molecular weight polyol dispersant is selected from the group consisting of low molecular weight polysaccharides having a degree of polymerization (DP) in the range of 2-100, preferably in the range of 2-50. In some embodiments, the low molecular weight polyol dispersant is selected from the group consisting of low molecular weight polysaccharides having a degree of polymerization (DP) in the range of 2-12. The low molecular weight polysaccharides may be charged, uncharged, amphoteric, or combination thereof. The low molecular weight polysaccharides may be linear or branched.

In some embodiments, the low molecular weight polyol dispersant is a sugar alcohol, preferably a sugar alcohol selected from the group consisting of sorbitol, maltitol, xylitol, mannitol, and glycerol, and combinations thereof. In some embodiments, the low molecular weight polyol dispersant is selected from the group consisting of sorbitol, maltitol, xylitol, mannitol, and combinations thereof. In some embodiments, the low molecular weight polyol dispersant is sorbitol.

In some embodiments, the dispersion coated fiber-based substrate further comprises 0.01-15 wt %, preferably in the range of 0.01-10 wt %, and more preferably in the range of 0.1-5 wt %, of a rheology modifier, based on the total solid content of the dispersion coating layer.

In some embodiments, the rheology modifier comprises a polymer selected from the group consisting of polysaccharides, polysaccharide derivatives, polypeptides, polypeptide derivatives, or a combination thereof.

In some embodiments, the dispersion coated fiber-based substrate further comprises 1-30 wt % of filler particles, based on the total solid content of the dispersion coating layer.

In some embodiments, the filler particles are selected from the group consisting of clay, talcum, CaCO₃, TiO₂, Al₂O₃, SiO₂, bentonite, fibers, phyllosilicates, or a combination thereof.

In some embodiments, the dispersion coating layer comprises at least 50 wt % of PHA (polyhydroxyalkanoate) particles, the low molecular weight polyol dispersant in the amounts disclosed herein, optionally a rheology modifier in the amounts disclosed herein, and optionally filler particles in the amounts disclosed herein, based on the total solid content of the dispersion coating layer. In some embodiments, the dispersion coating layer comprises at least 70 wt % of PHA (polyhydroxyalkanoate) particles, 7.5-30 wt % of the low molecular weight polyol dispersant, 0.1-5 wt % of the rheology modifier, and optionally 5-25 wt % of the filler particles, based on the total solid content of the dispersion coating layer.

In some embodiments, the dispersion coating layer is free from added foaming agents, such as non-polymeric or polymeric surfactants. In some embodiments, the dispersion coating layer comprises less than 0.5 wt %, preferably less than 0.1 wt %, more preferably less than 0.01 wt %, of added foaming agents, such as non-polymeric or polymeric surfactants.

In some embodiments, the dispersion coating layer is de-aerated. Thus, in some embodiments, the dispersion coating layer is preferably free from, or substantially free from bubbles of air and other gases.

In some embodiments, the dispersion coating layer has a grammage in the range of 5-40 g/m², preferably in the range of 5-30 g/m², and more preferably in the range of 5-20 g/m². In some embodiments, the dispersion coating layer has a thickness in the range of 8-20 μm.

In some embodiments, the dispersion coated fiber-based substrate has a L&W (15°) bending resistance of at least 145 mN (MD) as determined according to ISO 2493-1.

In some embodiments, the dispersion coated fiber-based substrate further comprises a heat sealable liquid barrier layer on the second main surface.

In some embodiments, it may be preferred to coat both of the main surfaces of the fiber-based substrate with the PHA dispersion coating. Thus, in some embodiments, the dispersion coated fiber-based substrate further comprises a dispersion coating layer comprising
50-99 wt % of PHA (polyhydroxyalkanoate) particles, based on the total solid content of the dispersion coating layer, and
1-50 wt % of low molecular weight polyol dispersant, based on the total solid content of the dispersion coating layer,
   on the second main surface.

The dispersion coating layer on the second main surface may be further defined as the dispersion coating layer on the first main surface. The dispersion coating layer on the second main surface may be identical to, or different from, the dispersion coating layer on the first main surface.

In some embodiments, the dispersion coated fiber-based substrate has a water vapor transmission rate (WVTR), measured according to the standard ASTM F1249-20 at 50% relative humidity and 23° C., of less than 25 g/m²/24 h, preferably less than 20 g/m²/24 h, and more preferably less than 17 g/m²/24 h.

In some embodiments, the dispersion coated first main surface of the dispersion coated fiber-based substrate has a COBB600 value, measured according to the standard ISO 535:2014, of less than 25 g/m², preferably less than 20 g/m², and more preferably less than 15 g/m².

In some embodiments, the dispersion coated first main surface of the dispersion coated fiber-based substrate has a KIT value of at least 5, preferably at least 10, measured according to TAPPI standard T 559.

In some embodiments, the dispersion coated first main surface of the dispersion coated fiber-based substrate is pinhole free. The number of pinholes may for example be determined by optical inspection according to standard EN13676:2001. The substrate film preferably comprises less than 10 pinholes/m², preferably less than 8 pinholes/m², and more preferably less than 2 pinholes/m², measured according to standard EN13676:2001.

The dispersion coated fiber-based substrate may be recycled into other paper products using common repulping technology. In the repulping, the cellulose fibers of the fiber-based substrate are separated from a non-repulpable fraction referred to as rejects. Rejects may for example comprise agglomerated fibers and solid foreign materials, that have to be removed for disposal or converting into energy. In some embodiments, the dispersion coated fiber-based substrate has a repulpability characterized by a reject rate, as determined according to the PTS RH 021/97 test method for Category II products, below 20%, preferably below 10%, more preferably below 5%. The dispersion coated fiber-based substrate thus provides very good repulpability. The dispersion coated fiber-based substrate may thus be referred to as a repulpable material.

In some embodiments, the dispersion coated fiber-based substrate is biodegradable and compostable according to standard EN 13432.

According to a third aspect illustrated herein, there is provided a method for manufacturing a dispersion coated fiber-based substrate, said method comprising the steps of:
a) providing a fiber-based substrate having a first main surface and a second main surface;
b) forming a dispersion coating layer by applying a dispersion coating composition as defined with reference to the first aspect on the first main surface and drying the applied dispersion coating composition.

In some embodiments, the method further comprises:
c) forming a heat sealable liquid barrier on the second main surface.

In some embodiments, the dispersion coating composition is further defined as set out herein with reference to the first aspect.

In some embodiments, the fiber-based substrate is further defined as set out herein with reference to the second aspect.

The inventive method may be implemented on-line in full scale paper or paperboard machines.

The dispersion coating layer is preferably formed by means of a liquid film coating process, whereby the dispersion coating composition is applied on the substrate, spread out to a thin, uniform layer, and thereafter dried.

In some embodiments, the dispersion coating composition is applied at a grammage in the range of 5-40 g/m², preferably in the range of 5-30 g/m², and more preferably in the range of 5-20 g/m², based on dry weight. The thickness of the wet dispersion coating composition when applied on the substrate is typically in the range of 20-100 μm, preferably in the range of 20-50 μm. Accordingly, it is preferred that the dispersion coating composition is free from particles or particle agglomerates that are larger than 20-50 μm. Thus, in some embodiments, the dispersion coating composition is free from, or substantially free from particles or particle agglomerates having a particle size above 50 μm, above 20 μm, or above 15 μm.

In some embodiments, the dispersion coating composition is applied by a non-contact application method. In some embodiments, the dispersion coating composition is applied by an application method selected from the group consisting of roller coating, spray coating, curtain, blade coating, slot coating, immersion coating, gravure roll coating, reverse direct gravure coating, rod coating, soft-tip blade coating, short dwell, and soft-tip rod coating, and combinations thereof. In some embodiments, the dispersion coating composition is applied by blade coating or rod coating. The dispersion coating composition may be applied directly onto the fiber-based substrate or indirectly, for example via a transfer roll or belt.

To minimize the risk of pinholes in the dispersion coating layer, the dispersion coating layer may be formed by applying the dispersion coating composition in two or more steps with interim drying between the steps. In such embodiments, the dispersion coating composition in each step may be applied at a grammage in the range of 5-10 g/m², based on dry weight. In some embodiments, the dispersion coating composition applied in the first step may be different from the dispersion coating composition applied in the second step. In some embodiments, the PHA particles in the dispersion coating composition applied in the second step have a median particle size which is smaller than the median particle size of the particles in the dispersion coating composition applied in the first step. In some embodiments, the median PHA particle size in the second step is at least 10% smaller, preferably at least 20% smaller and more preferably at least 30% smaller, than the median PHA particle size in the first step.

In some embodiments, the drying comprises subjecting the dispersion coating composition to heating. In some embodiments, the drying comprises subjecting the dispersion coating composition to at least one non-contact drying step, such as infrared radiation, electron beam radiation, ultraviolet radiation, microwave radiation, hot air, such as impingement, or a combination thereof. Optionally, the dispersion coating composition is then subjected to at least one additional drying step, which can be a hot air drying step or a contact drying step, such as heat conduction drying, e.g. using a heated belt or heated cylinders.

In some embodiments, the dry dispersion coating layer has a grammage in the range of 5-40 g/m², preferably in the range of 5-30 g/m², and more preferably in the range of 5-20 g/m². In some embodiments, the dry dispersion coating layer has a thickness in the range of 8-20 μm.

In some embodiments, the obtained dispersion coated fiber-based substrate is further defined as set out herein with reference to the second aspect.

In some embodiments, both the fiber-based substrate provided in a), and the dispersion coated fiber-based substrate obtained in b), have a L&W (15°) bending resistance of at least 145 mN (MD) as determined according to ISO 2493-1.

According to a fourth aspect illustrated herein, there is provided a packaging container comprising a dispersion coated fiber-based substrate as defined with reference to the second aspect.

The dispersion coating layer of the inventive dispersion coated fiber-based substrate has been found particularly useful as a moisture/liquid barrier for use on the outside surface of food and liquid packaging containers. Thus, in some embodiments, the dispersion coated first main surface forms an outside surface of the container.

The packaging container is particularly useful for liquids, greasy foods, dry foods and/or frozen foods. In embodiments, the packaging is a beverage container, preferably a cup.

In some embodiments, the packaging container is biodegradable and compostable according to standard EN 13432.

The dispersion coated fiber-based substrates of the present disclosure preferably exhibit some or all of the following properties:
Low coat weights, preferably in the range of 5-20 g/m²
Substantially pinhole free dispersion coating layer
Low COBB600 value, preferably below 25 g/m²
Grease resistance, KIT value preferably >10.
Good crack resistance
Repulpable, PTS reject rate as determined according to the PTS RH 021/97 test method for Category II products preferably below 20%
Home and industrially compostable
Printable

Generally, while the products, polymers, materials, layers and processes are described in terms of “comprising” various components or steps, the products, polymers, materials, layers and processes can also “consist essentially of” or “consist of” the various components and steps.

While the invention has been described with reference to various exemplary embodiments, it will be understood by those skilled in the art that various changes can be made, and equivalents may be substituted for elements thereof, without departing from the scope of the invention. In addition, many modifications may be made to adapt a particular situation or material to the teachings of the invention without departing from the essential scope thereof. Therefore, it is intended that the invention is not limited to the particular embodiment disclosed as the best mode contemplated for carrying out this invention, but that the invention will include all embodiments falling within the scope of the appended claims.

### EXAMPLES

In order to evaluate the inventive dispersion coating composition a series of tests was performed. The dispersion coating compositions were prepared by adding dry PHA to a water-based solution comprising the dispersant, whereafter the other components were then added. All percentages calculated as dry solid content (wt %).

### Example 1 (Comparative)—PVOH as Dispersant with Filler Particles

A poly(3-hydroxybutyrate-co-3-hydroxyhexanoate) (PHBH) dispersion with a PVOH based dispersant was prepared, and filler particles were added (see Table 1, Reference 1). The stability of the dispersion was poor, which resulted in graininess and uneven coating quality. Paperboard was coated on one side with the dispersion coating composition in a pilot rod coater, and the barrier properties and stiffness of the coated paperboard was evaluated. The paperboard was coated in two steps with interim drying between the steps. COBB600 values were high, indicating poor water barrier properties. The dispersion coating composition gave high amount of foam during preparation, and also afterwards, during disintegration of the sample sheets.

### Example 2 (Comparative)—PVOH as Dispersant without Filler Particles

A poly(3-hydroxybutyrate-co-3-hydroxyhexanoate) (PHBH) dispersion with a PVOH based dispersant was prepared (see Table 1, Reference 2). The stability of the dispersion was poor, which resulted in graininess and uneven coating quality. Paperboard was coated with the dispersion coating composition in a pilot rod coater, and the barrier properties and stiffness of the coated paperboard was evaluated. The paperboard was coated on one side in two steps with interim drying between the steps. COBB600 values were high, indicating poor water barrier properties. The dispersion coating composition gave high amount of foam during preparation, and also afterwards, during disintegration of the sample sheets.

### Example 3—Sorbitol as Dispersant without Filler Particles

A poly(3-hydroxybutyrate-co-3-hydroxyhexanoate) (PHBH) dispersion with sorbitol as dispersant was prepared (see Table 1, Dispersion 1). A rheology modifier (water soluble polysaccharide) was added to the dispersion and a small amount of defoamer was added to control the air bubbles in the dispersion caused by rigorous mixing during the preparation of the dispersion. The stability of the dispersion was good, which resulted in even coating quality. Paperboard was coated with the dispersion coating composition in a pilot rod coater, and the barrier properties and stiffness of the coated paperboard was evaluated. The paperboard was coated on one side in two steps with interim drying between the steps. COBB600 values were low, indicating good water barrier properties. The grease resistance as measured by KIT method according to TAPPI standard T 559 was acceptable. The dispersion coating composition did not give foam formation during preparation, or afterwards, during disintegration of the sample sheets.

### Example 4—Sorbitol as Dispersant with Filler Particles

A poly(3-hydroxybutyrate-co-3-hydroxyhexanoate) (PHBH) dispersion with sorbitol as dispersant was prepared (see Table 1, Dispersion 2). A rheology modifier and filler particles were added to the dispersion and a small amount of defoamer was added to control the air bubbles in the dispersion caused by rigorous mixing during the preparation of the dispersion. The stability of the dispersion was good, which resulted in even coating quality. Paperboard was coated with the dispersion coating composition in a pilot rod coater, and the barrier properties and stiffness of the coated paperboard was evaluated. The paperboard was coated on one side in two steps with interim drying between the steps. A coating on paperboard was prepared as set out in Table 2. COBB600 values were low, indicating good water barrier properties. The KIT value was good. The dispersion coating composition did not give foam formation during preparation, or afterwards, during disintegration of the sample sheets.

### Example 5—Different Dispersion Coating Compositions

Paperboard was coated with dispersion coating composition in a pilot rod coater, and the barrier properties and stiffness of the coated paperboard was evaluated. The paperboard was coated on one side in two steps with interim drying between the steps. The coating was prepared as set out in Table 2 using the Dispersion 1 of Example 3 in the first coating step and the Dispersion 2 of Example 4 in the second coating step. COBB600 values were low indicating good water barrier properties. The KIT was acceptable. The dispersion coating composition did not give foam formation during preparation, or afterwards, during disintegration of the sample sheets.

TABLE 1
Dispersion coating compositions

| Raw material | Reference 1 | Reference 2 | Dispersion 1 | Dispersion 2 |
|---|---|---|---|---|
| PHBH | 56 | 79 | 84.6 | 76.5 |
| Talcum | 32 | | | 9.5 |
| Dispersant 1 | 11.2 | 20.2 | | |
| Dispersant 2 | | | 14.8 | 13.4 |
| Rheology | 0.8 | 0.8 | 0.5 | 0.5 |
| modifier | | | | |
| Defoamer | | | 0.05 | 0.05 |
| NaOH | | | 0.05 | 0.05 |
| Total dry | 57 | 48.2 | 47.2 | 47 |
| content | | | | |
| Visual | Yes, large | Yes, large | Stable, | No |
| agglomerates | agglomerates | agglomerates | homogenous | agglomeration, |
| | | | | stable and |
| | | | | homogenous |
| | | | | dispersion |

TABLE 2
Dispersion coated paperboard samples

| | Example 1 | Example 2 | Example 3 | Example 4 | Example 5 |
|---|---|---|---|---|---|
| Number of | 2 | 2 | 2 | 2 | 2 |
| layers | | | | | |
| Coat | 15 | 17 | 17 | 20 | 19 |
| weight | | | | | |
| Type of | Ref 1 | Ref 2 | Disp 1 | Disp 2 | Disp 1 + |
| dispersion | | | | | Disp 2 |
| Grammage | 248 | 250 | 250 | 253 | 251 |
| KIT | <1 | 9 | 7 | 12 | 7 |
| Cobb600 | >60 | 48 | 11 | 13 | 21 |
| WVTR | Over | 74 | NA | 17 | NA |
| (23 C./50%) | range | | | | |

1. A dispersion coating composition for coating of a fiber-based substrate, said dispersion coating composition comprising, in a liquid medium:
50-99 wt % of polyhydroxyalkanoate (PHA) particles, based on a total solid content of the dispersion coating composition, and
1-50 wt % of low molecular weight polyol dispersant, based on the total solid content of the dispersion coating composition,
wherein the total solid content of the dispersion coating composition is in a range of 20-80 wt %.

2. The dispersion coating composition according to claim 1, wherein the PHA particles have a unimodal particle size distribution.

3. The dispersion coating composition according to claim 1, wherein the PHA particles have a median particle size (D50) below 15 μm.

4. The dispersion coating composition according to claim 1, wherein the dispersion coating composition is free from particles or particle agglomerates having a particle size above 50 μm.

5. The dispersion coating composition according to claim 1, wherein the PHA particles comprise PHA in an amount of 70-99.9 wt %, based on a dry weight of the PHA particles.

6. The dispersion coating composition according to claim 1, wherein the PHA is selected from a group consisting of: poly(3-hydroxyoctanoate) (PHO), poly(3-hydroxydecanoate) (PHD), poly(3-hydroxyhexanoate) (PHH), and poly(3-hydroxyvalerate) (PHV), poly(3-hydroxybutyrate-co-3-hydroxyvalerate) (PHBV), poly(3-hydroxybutyrate-co-3-hydroxyhexanoate) (PHBH), poly(3-hydroxybutyrate-co-4-hydroxybutyrate) (P3HB4HB), poly(3-hydroxyoctanoate-co-3-hydroxyhexanoate) (PHOHH), poly(3-hydroxyoctanoate-co-3-hydroxydecanoate) (PHOHD), and poly(3-hydroxyoctanoate-co-3-hydroxydodecanoate) (PHDHDD), and combinations thereof.

7. The dispersion coating composition according to claim 1, wherein the dispersion coating composition comprises 3-35 wt % of the low molecular weight polyol dispersant, based on the total solid content of the dispersion coating composition.

8. The dispersion coating composition according to claim 1, wherein the low molecular weight polyol dispersant has a molecular weight in a range of 50-2000 g/mol.

9. The dispersion coating composition according to claim 1, wherein the low molecular weight polyol dispersant is selected from a group consisting of: low molecular weight polysaccharides and sugar alcohols, and combinations thereof.

10. A dispersion coated fiber-based substrate, comprising:
a fiber-based substrate having a first main surface and a second main surface; and,
on the first main surface, a dispersion coating layer comprising
50-99 wt % of polyhydroxyalkanoate (PHA) particles, based on a total solid content of the dispersion coating layer, and
1-50 wt % of low molecular weight polyol dispersant, based on the total solid content of the dispersion coating layer.

11. The dispersion coated fiber-based substrate according to claim 10, wherein the dispersion coating layer comprises 3-35 wt % of the low molecular weight polyol dispersant, based on the total solid content of the dispersion coating layer.

12. The dispersion coated fiber-based substrate according to claim 10, wherein the low molecular weight polyol dispersant has a molecular weight in a range of 50-2000 g/mol.

13. The dispersion coated fiber-based substrate according to claim 10, wherein the low molecular weight polyol dispersant is selected from a group consisting of: low molecular weight polysaccharides and sugar alcohols, and combinations thereof.

14. A method for manufacturing a dispersion coated fiber-based substrate, said method comprising the steps of:
a) providing a fiber-based substrate having a first main surface and a second main surface;
b) forming a dispersion coating layer by applying the dispersion coating composition according to claim 1 on the first main surface and drying the applied dispersion coating composition.

15. A packaging container comprising: the dispersion coated fiber-based substrate according to claim 10.
